(19) United States
(12) Patent Application Publication
(10) Pub. No.: US 2016/0018125 A1
(43) Pub. Date: Jan. 21, 2016

(54) ENERGY MANAGEMENT SYSTEMS AND METHODS OF USE

(71) Applicant: GREENSLEEVES, LLC., Findlay, OH (US)

(72) Inventors: Stephen A. HAMSTRA, Zeeland, MI (US); Michael W LINN, Findlay, OH (US); Shane Richard MASON, Findlay, OH (US); Abram Richard GLAS, Perrysburg, OH (US)

(21) Appl. No.: 14/773,910

(22) PCT Filed: Mar. 4, 2014
(86) PCT No.: PCT/US14/20379

§ 371 Date: Sep. 9, 2015

Related U.S. Application Data
(60) Provisional application No. 61/772,502, filed on Mar. 4, 2013.
(60) Provisional application No. 61/785,818, filed on Mar. 14, 2013.
(60) Provisional application No. 61/785,804, filed on Mar. 14, 2013.

(51) Int. Cl. F24F 11/00; G05B 17/02

(52) U.S. Cl. CPC F24F 11/006; G05B 17/02

(57) ABSTRACT

A method of designing an optimized heating and cooling system includes: (1) simulating energy use of a virtual heating and cooling system operating a first potential thermal source or sink under a plurality of conditions; (2) simulating energy use of the virtual heating and cooling system operating a second potential thermal source or sink under a plurality of conditions; (3) optimizing the energy use of the virtual system operating the first potential thermal source or sink or the second potential thermal source or sink using neural network optimization; and (4) designing a heating and cooling system based upon the optimization of the energy use of the virtual system.

### CROSS REFERENCE TO RELATED APPLICATIONS

This application claims priority to U.S. Provisional Application No. 61/772,502, filed Mar. 4, 2013 and titled “GEOTHERMAL ENERGY MANAGEMENT SYSTEM,” U.S. Provisional Application No. 61/785,804, filed Mar. 14, 2013, and titled “ENERGY MANAGEMENT SYSTEMS AND METHODS OF USE,” and 61/785,818, filed Mar. 14, 2013, and titled “ENERGY MANAGEMENT SYSTEMS AND METHODS OF USE,” all of which are incorporated by reference in their entireties.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

Energy consumption in commercial and residential buildings is a very expensive component of the cost of operating and maintaining a building. For example, commercial buildings have expensive air conditioning and heating needs that, over the lifetime of the building(s), often add up to more than double the initial cost for construction. Attempts over the years to reduce energy consumption have resulted in adding substantial increases in construction costs that are often not recouped over the short term.

Buildings represent 40% of the energy used in the United States and are fueled almost entirely with fossil fuels that are expensive and damaging to the environment. Further, there are a number of problems that make building heating, ventilation, and cooling (HVAC) systems inefficient. These problems include: (1) pressure on construction costs encourages owners to keep up front costs low by purchasing inexpensive, wasteful HVAC systems; (2) wasting excess energy rejected through chillers, etc. rather than moving it to where it is needed or storing it for later use; (3) high energy movement through walls because of inadequate insulation; (4) constantly reheating and re-cooling the building mass rather than holding it at temperature; (5) overbuilt, inefficient systems that could be made much smaller; (6) the inability to use local energy (e.g. solar, body heat, etc.); (7) heating the building when the heating system is least efficient and likewise cooling the building when the cooling system is least efficient; and (8) the expense of renewable energy sources. The need thus exists a need for an energy and cost efficient heating and cooling system.

### SUMMARY

In general, in one embodiment, a method of designing an optimized heating and cooling system includes: (1) simulating energy use of a virtual heating and cooling system operating a first potential thermal source or sink under a plurality of conditions; (2) simulating energy use of the virtual heating and cooling system operating a second potential thermal source or sink under a plurality of conditions; (3) optimizing the energy use of the virtual system operating the first potential thermal source or sink or the second potential thermal source or sink using neural network optimization; and (4) designing a heating and cooling system based upon the optimization of the energy use of the virtual system.

This and other embodiments can include one or more of the following features. The method can further include virtually connecting each of the potential thermal sources or sinks in a model to simulate the performance of the entire system as a whole before the simulating steps.

Designing the heating and cooling system can further include selecting a plurality of thermal sources or sinks for use in the heating and cooling system. Designing the heating and cooling system can further include determining an optimum sequence of operation of the selected plurality of thermal sources or sinks. Designing the heating and cooling system can further include determining an optimal target size for each selected thermal source or sink. Designing the heating and cooling system can further include determining an optimum condition for each selected thermal source or sink. The plurality of conditions can include a plurality of flow rates to or from the first or second potential thermal source or sink. The plurality of conditions can include a plurality of capacities of the first or second potential thermal source or sink that may vary over time or over a range of conditions. The plurality of conditions can include a plurality of operating temperatures of the first or second potential thermal source or sink. The plurality of conditions can include a plurality of runtimes of the first or second potential thermal source or sink. The plurality of conditions can include operating cost of the first or second potential thermal source or sink. The plurality of conditions can include installation cost of the first or second potential thermal source or sink. The neural network optimization can be genetic algorithm optimization. The neural network optimization can be particle swarm optimization. At least one of the thermal sources or sinks can be a geothermal borefield. At least one of the thermal sources or sinks can be a closed-circuit cooling tower. Optimizing the energy use can include optimizing the energy use of the virtual system relative to cost. Designing a heating and cooling system based upon the optimization of the energy use of the virtual system can include selecting an actual thermal source or sink that corresponds to the first or second potential thermal source or sink.

In general, in one embodiment, a method of controlling a plurality of thermal energy sources or sinks of a heating and cooling system includes: (1) activating the plurality of thermal sources or sinks of the heating and cooling system based upon a predetermined control plan; (2) tracking the performance of the heating and cooling system and each of the thermal sources or sinks under the predetermined control plan; (3) modifying the predetermined control plan based upon the tracked performance; and (4) activating the plurality of thermal sources or sinks based upon the modified control plan.

This and other embodiments can include one or more of the following features. Each of the steps can be performed by a controller, and the controller can be a local controller on one or more of the plurality of thermal sources or sinks. Modifying the control plan can include modifying a sequence of operation of the plurality of thermal sources or sinks, a runtime of one of the plurality of thermal sources or sinks, or an optimum condition for one of the plurality of thermal sources or sinks. The method can further include gathering data related to occupancy, seasonality, or time of day, and modifying the control plan can further include modifying the control plan based upon the gathered data. The method can further include determining an optimum methodology for adjusting a quantity of thermal energy within one or more of the thermal source or sinks based upon the control plan, and activating the plurality of source or sinks can include adjusting the quantity of thermal energy based upon the determined methodology.

In general, in one embodiment, a method of controlling a plurality of thermal sources or sinks of a heating or cooling system includes: (1) predicting an increase or decrease in the temperature of one of the plurality of thermal sources or sinks; (2) determining an impact of the predicted increase or decrease on a capacity of the system, efficiency of the system, energy consumption of the system, or cost; and (3) adjusting a temperature of one of the plurality of thermal energy sources or sinks based upon the determined impact.

This and other embodiments can include one or more of the following features. The method can further include obtaining a weather forecast, and predicting an increase or decrease in the temperature of the thermal energy storage device can include predicting based upon the weather forecast. Determining an impact of the predicted increase or decrease can further include determining if a thermal mass of one of the plurality of thermal energy sources of sinks may be depleted or overfilled as a result of the increase or decrease in air temperature. The steps can be performed daily. The steps can be performed on a seasonal basis.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 shows exemplary elements of a geothermal HVAC system.

FIG. 2 is a chart showing gene creation for flow rates of a cooling tower for use with genetic algorithm optimization.

FIG. 3 is a chart showing gene crossover for genetic algorithm optimization.

FIG. 4 is a flow chart showing the use of neural networks to design a heating and cooling system.

FIG. 5 is a flow chart showing the compilation of design model and data files for embedded installation.

FIG. 6 is a flow chart showing a self-learning control system for a heating and cooling system.

FIG. 7 is a flow chart showing real-time performance adjustments for preconditioning.

### DETAILED DESCRIPTION

This disclosure is related to energy management systems and methods of use. The disclosure describes systems and methods of efficiently modeling energy systems, including the simulated uses thereof. The disclosure also describes systems and methods of efficiently capturing, storing and using energy from various sources via building energy systems.

Described herein is a method of designing an optimized heating and cooling system (or heating, ventilation, and air-conditioning (HVAC)) system that includes thermal sources and/or thermal sinks, a method of controlling a plurality of thermal sources or sinks, and a method for preconditioning individual thermal sources or sinks within a heating or cooling system. The methods described herein can be used with any suitable energy management systems including geothermal HVAC, hybrid geothermal HVAC, hybrid HVAC systems, high efficiency HVAC systems, and HVAC systems that include a thermal storage capability even though aspects of the disclosure are described with specific reference to geothermal energy management systems. The methods described herein can be used with any of the energy systems described in U.S. Patent Publication No. 2011/0272117, titled “Energy Chassis and Energy Exchange Device,” and filed May 5, 2011, the entirety of which is incorporated by reference herein.

One aspect of the disclosure includes methods of efficiently simulating and modeling energy systems. Efficient modeling and simulation of an energy system allows for automated optimization of the design of the energy system, including individual components. For example, an automated optimization can be used to optimize the design of the system based upon the most desirable cost and operational outcomes. The automated optimization modeling and design described herein can eliminate the need for extensive custom programming and long computational simulation periods. This is turn reduces the first cost of the energy system, which can be one of the impediments for installing higher first cost energy systems.

### Designing an Optimized HVAC System

The methodologies described herein utilize neural networks with advanced optimization techniques such as, for example, genetic algorithm optimization, reactive search optimization, and particle swarm optimization, to design or configure a heating and cooling system and determine the optimum sizing and control of the components.

Advanced computed neural network optimization methods, such as genetic algorithm optimization and particle swarm optimization that, combined with an application of the physics of soil thermal energy transfer (as expressed in a mathematical model embedded in the software) based on soil thermal conductivity, soil thermal diffusivity, and thermal energy storage, can be used to simulate both real-time and long-term operation of a heating and cooling system. The simulated system can then be optimized relative to control setpoints, the operation of auxiliary devices such as closed-circuit cooling towers, proactive thermal storage and/or energy usage.

In one embodiment, genetic algorithms can be used to solve optimization problems (such as of a heating and cooling system) by allowing certain combinations of variables, sometimes called “genes,” to combine and mutate randomly, mimicking the manner in which biological organisms evolve and adapt. The sets of genes can be considered to represent a population. Further, individual genes, which represent possible solutions to the optimization problem, can be randomly selected from the population in a process analogous to a tournament selection, in which the winners of the tournament are the fittest members of the population. The process involves combining genes, allowing genes to mutate randomly, and evaluating the solution's fitness in a tournament. The result is identification of the “winner,” or best combination of variables, as the solution that best solves the defined problem.

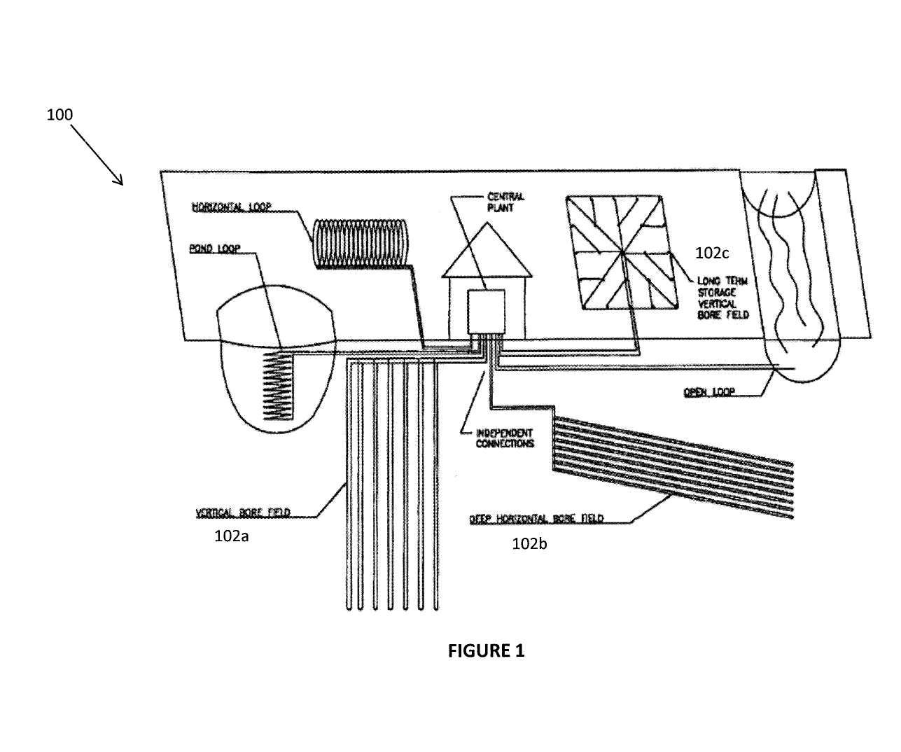

Thus, in reference to optimizing a heating and cooling system, the optimization problem defined can be optimization of the operation (energy use, cost, etc.) of an HVAC system, such as a geothermal HVAC system, hybrid geothermal HVAC system, or hybrid HVAC system. Referring to FIG. 1, in one example, the virtual system to be optimized can include one or more borefields and a cooling tower (though other thermal source or sinks, electrical energy storage devices, and or heat removal elements can similarly be used with the method described herein). Genes selections can include, for example, runtime, size or capacity, flow rate, operating temperature, operating cost, or installation cost of the borefield or cooling tower. To select the desired genes, borefield and cooling tower boundary conditions may be defined.

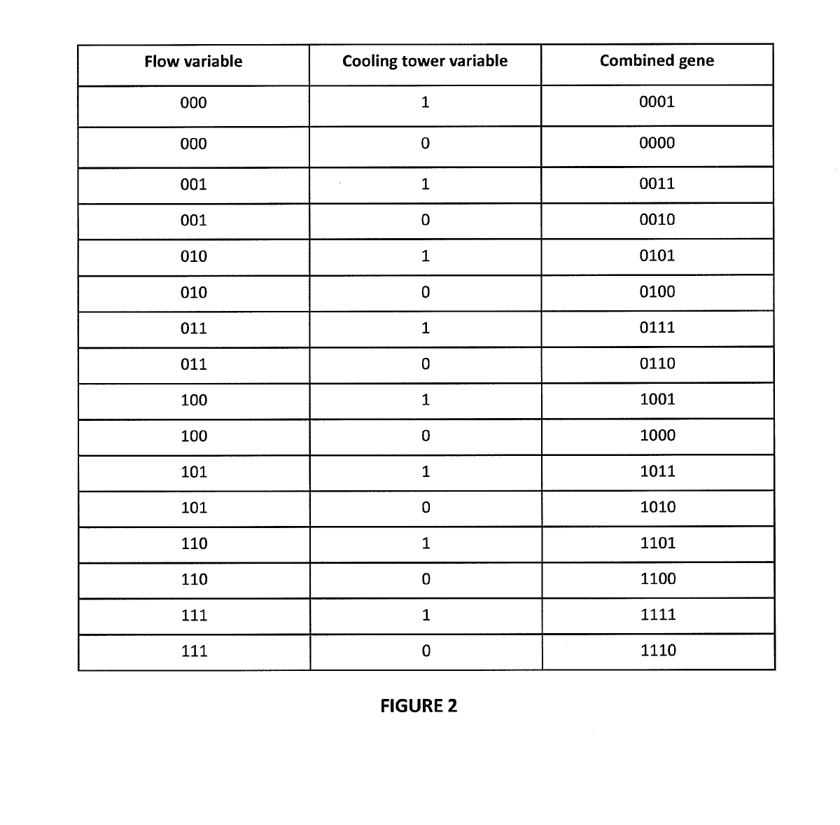

An exemplary set of genes for flow rate of water (or other heat transfer working fluid) through a cooling tower is shown in FIG. 2. In binary representation, it may be assumed that one flow rate may be represented by 000, a second by 001, a third by 010, a fourth by 011, a fifth by 100, a sixth by 101, a seventh by 110, and an eighth by 111. Then another digit may be added to the gene to indicate “0” for cooling tower size one and “1” for cooling tower size two. Therefore, the possible initial population set may be a complete permutation of all the above, as shown in FIG. 2. The entire population may be constructed from the list of all possible permutations of flow rates for the cooling tower. Alternatively, a random sample may be taken from the list of possible permutations.

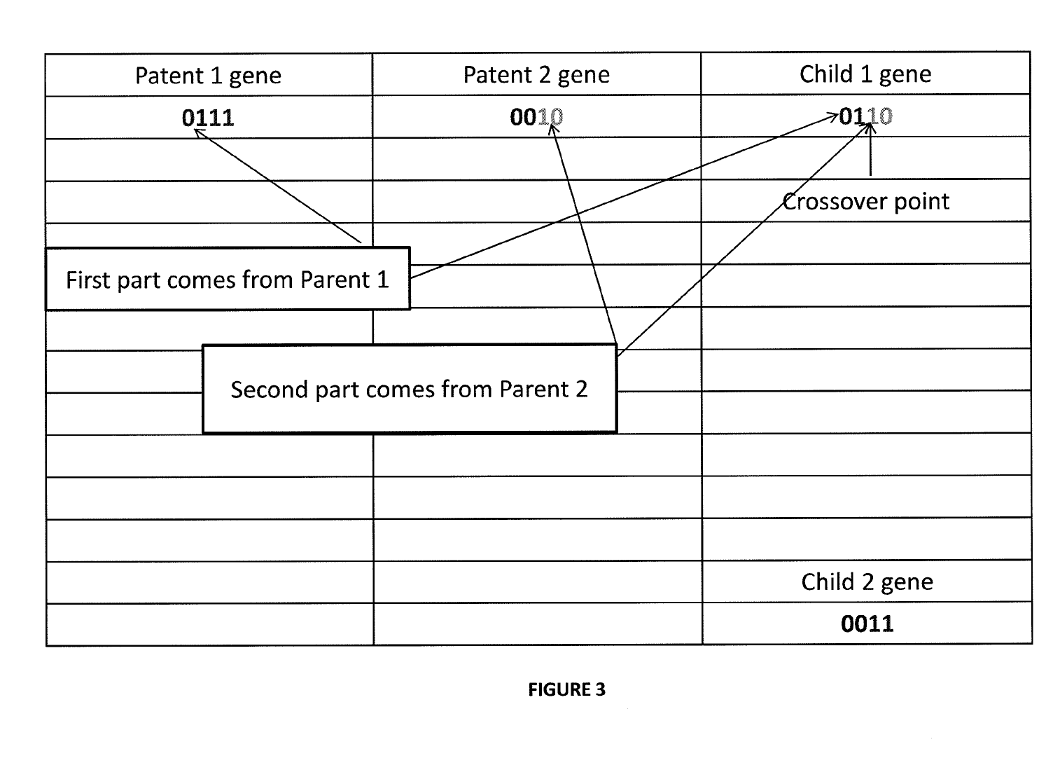

Referring to FIG. 3, the defined genes may be combined to generate “offspring” (new generations), and/or each parent gene may be allowed to produce offspring by crossover. A single point in the gene may be defined as the crossover point (a technique known as single-point crossover). A crossover point may be selected as the third digit in the gene. An exemplary gene produced by crossover is shown in FIG. 3. Each generation may be allowed to mutate one digit at random so as to ensure a genetically diverse population. Therefore, as shown in FIG. 3, the child 1 may be 0110 from crossover and no mutation, but then for the next child, the third digit is allowed to mutate, so instead of the second child becoming 0011 from crossover and no mutation, the second child would be 0001 from crossover and mutation of the third digit.

Once the population has been generated from permutation, crossover, and mutation, the optimization (or “tournaments”) can be performed. To do so, two genes are selected at random from the population. The one gene that is the most fit, or that represents the most optimum solution of the two, wins the “match,” and the losing gene is removed from the population. This process may repeat until there is only one gene remaining in the “tournament,” the remaining gene representing the most fit (or most optimum) of the original population.

The fitness of each gene is thus determined by using the physical quantity that it represents (such as flow rate or cooling tower size) as boundary conditions in a mathematical model of the system that includes the virtual borefield, cooling tower, pumps, and external loads. A computer or controller can be used to execute the mathematical model to generate a calculation of the quantity to be optimized (or minimized) such as, but not limited to, power or energy consumption, installed cost, operating cost, or size. When variable trade-off situations are evaluated, tradeoffs between options are considered in the model if done correctly. Therefore, as long as the objective function of the optimization algorithm is chosen such that the subject effect (or tradeoff) is evident and captured in the model, it will be captured by the algorithm as well.

In another embodiment, particle swarm optimization can be used to solve optimization problems (such as of a heating and cooling system). Particle swarm optimization is a stochastic, self-learning, artificial intelligence (AI) algorithm well suited to minimization and maximization problem solutions. Analogous to creating “genes” in genetic algorithms, combinations of variable in particle swarm optimization are randomly created to form “particles.” These particles are given an initial position (location) in the multi-dimensional solution space and a velocity vector (defined as both magnitude and direction) in that same space. Referring back to FIG. 1, particle selections can include, for example, runtime, size or capacity, flow rate, operating temperature, operating cost, or installation cost of the borefield(s) 102a,b or the cooling tower of system 100.

The random group of particles, each of which represents a solution to the problem (e.g. energy usage of the system 100), but may or may not be an optimized solution, constitutes a population. Each particle in the population (or “swarm”) has defined its current location (“position”) and current velocity. With the velocity vector defined, it is thus also known where the particle is going (direction of the velocity vector) and how long it will take to get there (magnitude of velocity) in the solution space. This a-priori knowledge of future locations of particles allows for calculation of successive generations of populations in the swarm. As each particle is evaluated, it is determined to be either a personal best or not. If the particle, as a possible solution to the optimization problem, represents a better (more optimum) solution to the problem at the current location than at any prior location of the same particle, the particle is deemed to be a personal best and is allowed to continue into the next population. If not, (i.e. it is “flying away” from the swarm) it is left behind in the solution space. Once each particle has been evaluated for personal best, then each particle is evaluated in a like manner to determine if it represents a global best. If a particle, as a possible solution to the problem at the current location, represents a better solution to the problem than any other position of any other particle, the particle is considered to be a global best.

In this manner, each new population is “moving” toward the optimum position in the global solution space, and once the population best is closest to the global best, and the global best value is not changing from population to population, the optimum solution has been reached. This particle swarm optimization can be used for any two-dimensional space defined by system equipment or operating characteristics. Thus, for example, the two dimensions could be borefield flow (or size) and cooling tower size or capacity. A random set of particles may be generated as a combination of borefield size and cooling tower capacity. This initial swarm of particles has its fitness evaluated by using the physical quantity that each dimension of each particle represents (such as borefield or cooling tower capacity) as boundary conditions in the mathematical model of the system consisting of the borefield, cooling tower, pumps, and external loads, and then performing a computer execution of the mathematical model to generate a calculation of the quantity to be optimized (or minimized) such as, but not limited to, power consumption, installed cost, operating cost, or capacity. Then each particle is allowed to move according to its velocity in solution space, and each particle is evaluated at each new position for personal and global fitness, until the optimized particle (solution) is found.

In some embodiments, as multiple optimization of sub-systems are completed, the subsystems are then integrated into a larger optimization of systems until an entire set of sub-systems has been optimized. Further, submodels that include energy harvesting, sensing, storage, transportation control and financial models can be easily manually or automatically integrated into a single integrated model. The models include pre-integrated software functionality capable of connecting a multitude of sources to a multitude of uses.

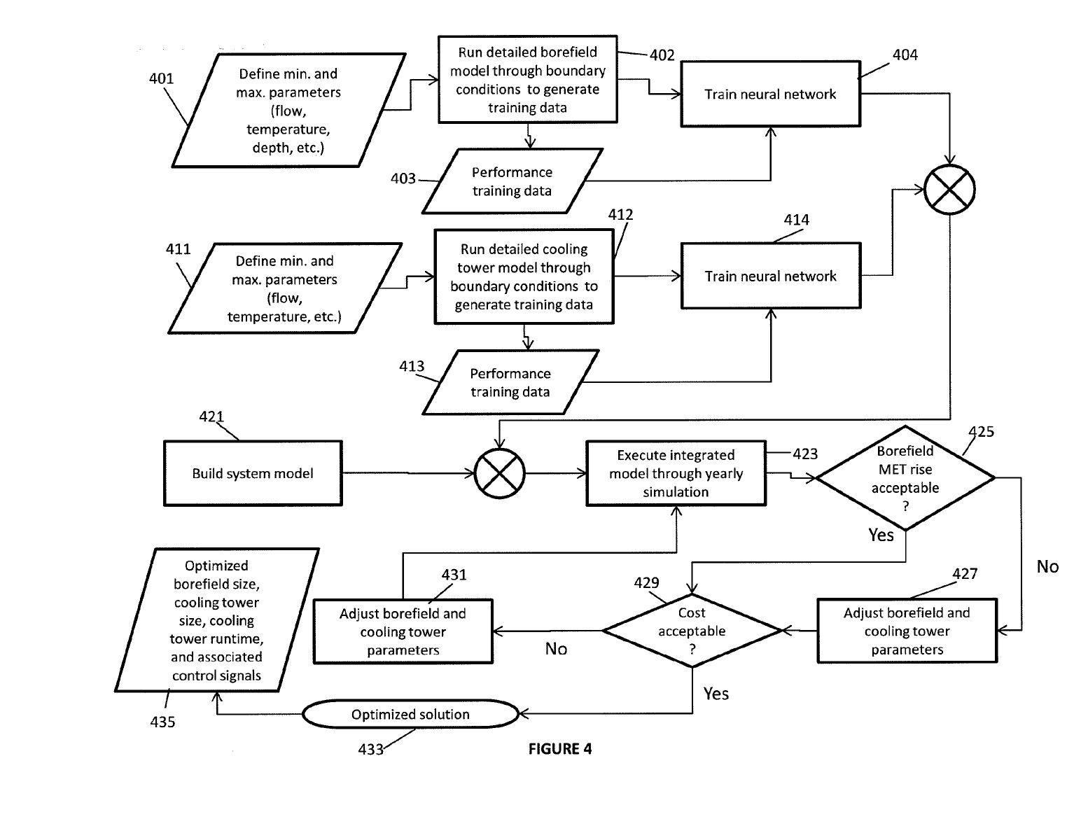

As described above, the neural network optimization techniques (e.g., genetic algorithm optimization and particle swarm optimization) can be used to design a heating and cooling system, such as a system including a geothermal borefield, auxiliary heat sources or sinks, and/or geothermal heat pumps. An exemplary flow chart for designing an optimized heating and cooling system is shown at FIG. 4. At step 401, the boundary conditions, e.g., minimum and maximum parameters (e.g., flow, temperature, and depth) for a borefield are defined. At step 402, a detailed borefield model can be run through the boundary conditions to generate training data. Previously known performance training data and the determined performance training data (step 403) can then be added to the neural network at step 404. Similar steps can be taken with respect to the cooling tower (see steps 411-414). A system model can be built at step 421 that, in combination with the trained neural networks from the borefield and the cooling tower (steps 404, 414), can be combined and then used to execute an integrated model at step 423. The integrated model can be executed through a simulation that extends over a period of time, such as a year. It can then be determined whether the borefield mean effective earth temperature (MET) rise within the borefield is acceptable at step 425. The MET within the borefield is used to determine the borefield's ability to efficiently absorb or release thermal energy and also determined the temperature range of the heat transfer fluid entering the geothermal HVAC system which in turn determines that system's efficiency. If the MET rise is not acceptable, then the borefield and cooling tower parameters can be adjusted at step 427. If the borefield MET rise is acceptable or if the borefield and cooling tower parameters have been adjusted, it can then be determined at step 429 whether the cost (which could be initial cost, life cycle cost, etc.) of the designed system (i.e. geothermal borefield and closed-circuit cooling tower, etc.) is acceptable. If not, the borefield and cooling tower parameters can be adjusted against at step 431. If the cost is acceptable, then it can be determined that the optimized solution has been obtained at step 433. At step 435, the optimized system can thus be designed or configured (including the optimized borefield size, cooling tower size, cooling tower runtime, and associated control signals).

Thus, as shown in the exemplary method outlined in FIG. 4, the design optimization techniques described herein can be used to optimize and automate the design and operation (generation of control algorithms) of a geothermal borefield, auxiliary heat sources/sinks and/or geothermal heat pumps. In this exemplary embodiment, borefield boundary conditions (e.g., flow inlet temperature) and parameters (e.g., depth) can be defined and neural network training data can be performed for the defined borefield. Using the training data, a model of the borefield can be generated. Simulation boundary conditions (e.g., loop temperature limits) can be defined by a user, and an algorithm can be executed to automatically optimize the borefield size and cooling tower (or other heat removal element) size for the lowest installed cost and for the lowest annual mean earth temperature rise (or lowest other selected variable such as first cost, electrical peak demand, energy consumption, etc.) with an optimized cooling tower run schedule. This is merely an exemplary method in which the system borefield size and/or cooling tower capacity can be optimized for lowest total capital/labor installation cost and lowest annular mean earth temperature rise, with an optimum heat removal device run schedule. The same process can be used to optimize any hybrid (more than one heating, or cooling source) HVAC system where some form of thermal energy storage is employed. The results of the optimization then are available to inform the system designer on best modifications to the original system design concept based on this new energy model.

The automated and optimized design techniques described herein advantageously allows for modeling of all heating and cooling components and the building or multiple buildings in an interactive, integratable, replicable model. The methods herein can be used with plug and play models with input and output tables for easy integration of environmental and fossil energy. This design optimization tool allows the energy usage of the heating and cooling system to be optimized in a time and power-efficient manner, reducing a process that might take three days of engineering time down to two hours of computing time with a controller.

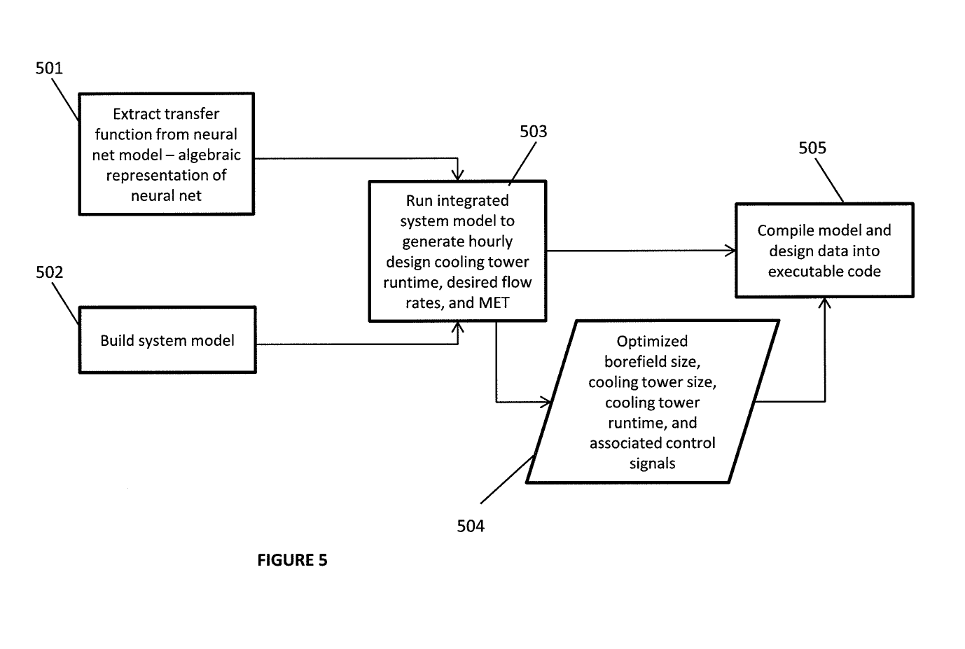

Referring to FIG. 5, the design controls for the optimized system developed from the neural network approaches described above can further be built into the control-system of the system. Further, the control algorithms can be executed directly on the local (on-board the local programmable digital controller) controller of the HVAC the equipment (also herein referred to as the “embedded system”). Previously, software algorithms for optimizing a system were not able to fit or function onboard a small, HVAC-level controller (which often includes 16 bit microprocessors and limited RAM). However, the neural network mechanisms described herein allows huge reductions in both CPU time and CPU “horsepower” (for example, a reduction in simulation time from about 8 to about 10 hours has been reduced to about 5 minutes). Moving the control algorithms to the machine level (instead of on remote computers) improves the operational efficiency, increases system reliability, and reduces the first and on-going costs of system controls and their operations while it allows the system to operate without being connected to a larger computer.

Thus, referring to FIG. 5, a transfer function from the neural net model can be extracted at step 501. In some methods, transfer function and coefficients are stored in data files, eliminating the need for the custom code or neural net to be on the programmable logic controller or the local HVAC control device. The extracted transfer function and the system model (built at step 502) can be integrated into a system model to generate precise control parameters for a cooling tower at step 503. In an exemplary method of use, a transfer function calculates the mean effective earth temperature (“MET”), flow outlet temperature of the geothermal borefield, the design MET, the closed circuit cooling tower (or other heat rejection device) run schedule, and updates the schedule based on past (historical) performance. The method then predicts cooling requirement deviations from the original simulation model out a specific number of days (e.g., 1, 2, 3, 4, 5, 10, 20, 30, or any other number) ahead. At step 504, the control signals can be determined. Based upon the control signals and the integrated model a final model and design can be compiled into executable code for the local controller at step 505.

### Self-Learning

The control system including neural network optimization can advantageously allow the control system to “self-learn.” That is, the neural network approach allows the heating and cooling systems to observe actual thermal loads and the subsequent reaction of the geothermal, hybrid geothermal, or hybrid HVAC system energy assets, and then use these observations to learn and adapt on-going control approaches to provide optimal operation.

The “self-learning” attributes described herein are a significant improvement over current fixed algorithm control systems applied today. The fixed algorithm approach, where the HVAC controls are custom-edited when the system is installed, provides its best operation only when initially commissioned and cannot adapt over time. The self-learning control approach allows an operational efficiency improvement over time as it learns not only the building load profiles (which change over time), but also how the geothermal asset (or other thermal assets) reacts to these loads. For example, the building peak cooling load may be lower than original determined in the design simulation process and, as a result, the desired temperatures of the geothermal heat exchanger will be different to allow optimal energy consumption. Self-adapting controls will take this into consideration and change pre-conditioning algorithms for the earth heat exchanger.

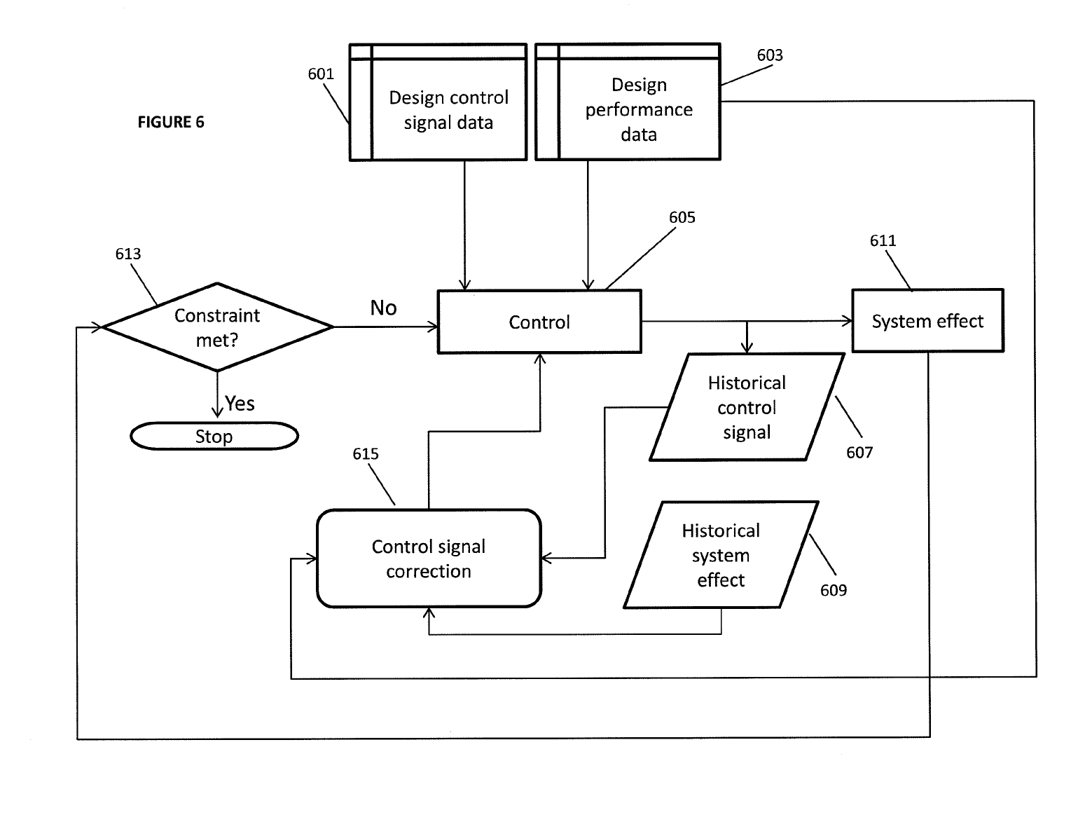

This self-learning control approach is analogous to a closed feedback loop. In an open loop with no feedback and no local or embedded design data, the controller makes reactionary changes to control signals in order to satisfy some goal (such as a temperature constraint) in real time and has neither a-priori knowledge of the desired design performance and/or control signal nor of the effect its control signal made in the system as a whole, beyond the manifestation of this effect as a change, or response, in the constraint. Referring to FIG. 6, in the disclosed embodiment, three additional steps are taken. First, the design performance (step 603) and expected control signals (step 601) required to effect the design performance are loaded into the embedded system so that the controller begins with a-priori knowledge of how the system is desired or designed to perform (step 605). Second, the controller maintains or is provided a feedback loop that encompasses actual performance of the system to recognize how the system responds to its design control signals in real time (steps 611, 613). Finally, the controller records these historical responses (steps 607, 609) and makes corrections to the future design control signals (615), and therefore learns how its past decisions affected the desired outcome and thus how to make adjustments to future decisions to achieve the desired outcome.

One example of self-learning includes having the controller track the actual thermal loads of the system. This involves measuring the thermal transport properties of the working fluid (the heat transfer medium between the building thermal loads and the heat sources and rejecters) and storing those temporal measurements on the embedded system. In like manner, the performance of the heat sources and rejecters, as well as the system comprising the building, heat sources, heat rejecters, and components whose behavior is governed by the controller (behavior that can be influenced by the controller, such as, but not limited to, control valve opening and closing, pumps turning on and off, pumps and fans speeding up and slowing down, etc.) is also stored in the embedded system. The design performance of the system and devices is also stored in the embedded system. Periodically, the temporal aggregate of the control decisions made, as well as these actual performance measurements, are compared to the design performance. By making continual periodic comparisons of the design performance to the observed actual performance, the controller may determine if either its control decisions have been incorrect or inadequate, or if some unknown (stochastic) factor (or plurality of factors) has caused the actual performance of the system to deviate from the design performance so that it may make corrections and/or adjustments to its design performance and subsequently to its control commands in the future, thereby learning how to adjust the design performance to effecting actual performance of the system. In doing so, the system can more closely resemble the performance that the system was designed to achieve and/or improve performance beyond the original design expectation.

Another example of self-learning is as follows. The design performance of a system, that system consisting of a building and its associated thermal load on the hydronic (working fluid) system, the hydronic pumps, a borefield, and a cooling tower, can be calculated from the design optimization model previously described, and this performance can loaded into the controller in a collection of data files. The design calculations of required pump speeds and cooling tower run time are stored on the controller in like manner. The controller records historical values of actual system thermal loads, pump speed, and cooling tower run time. Initially, the controller issues commands to the pumps and cooling tower to run according to their design performance commands. Additionally, the controller will periodically perform a comparison between the design performance and the measured (actual) performance of the system in response to the control commands that were previously issued by the controller to the fore, the embedded system learns the actual, historical performance of the system in response to the control commands it has issued. Using the difference between the design performance and observed actual performance, the controller may calculate certain correction factors to be applied to future design performance commands and may continue to perform these corrections to design performance commands until such time as the measured actual performance is in agreement with the design performance.

Advantageously, the ability to apply this intelligent design and operation technology allows for pre-configured control solutions (with adaptation of those solutions) rather than requiring custom control code for every geothermal HVAC, or hybrid HVAC project. The control algorithms remain the same with only the alteration of the neural network formulae that define how the various portions of the system react to different load inputs.

### Preconditioning

The heating and cooling control systems described herein can include seasonal preconditioning, or daily preconditioning (i.e., an adjustment of the temperature of some form of thermal energy storage in anticipation of a projected future event or trend). Preconditioning can include predicting the future building energy demand, the future supply and cost of multiple types of energy, and how long and for what cost the energy can be stored and what costs that energy will defer based on information about the situation, for example, loads, weather, energy costs, and projected (future horizon) energy needs.

In one example, a heat rejection device (e.g., a closed-circuit cooling tower or other similar system) capacity and efficiency is related to the temperature difference between the fluid temperature (in the geothermal HVAC, hybrid geothermal HVAC, or hybrid HVAC system system) and the temperature of the heat rejection device (which might be the outside air dry bulb or wet bulb temperature). Using either design or history based prediction of building thermal loads, the control algorithm determines the projected building geothermal loop fluid temperature and then reviews the weather forecast and energy rate structure along with the predicted energy availability from multiple sources (like projected weather, occupancy, etc.) to determine the most efficient (or least costly) time to operate the heat rejection device. This approach may determine if the system should operate at night, or winter when the energy cost and outside conditions may be lower or cooler, or may determine that it is more efficient or more cost effective to wait until the building loop is warmer (typically late afternoon, or summer) and operate the heat rejection device at that time.

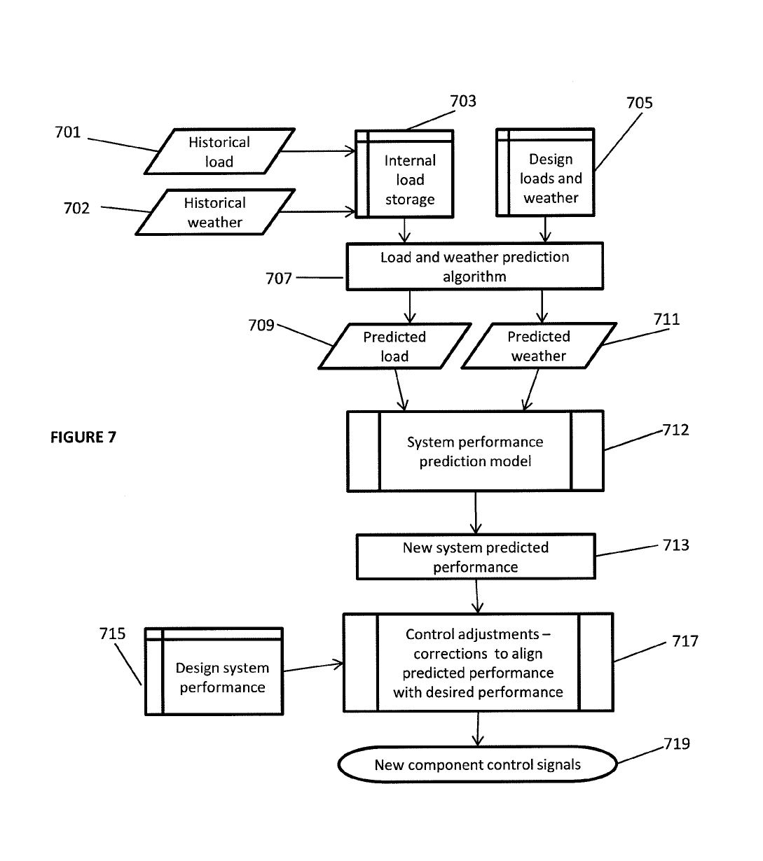

In an exemplary method of energy use, an actual building load on the energy system is determined from actual data, as shown in FIG. 7. Thus, the historical load (step 701) and historical weather (step 702) are loaded into an internal storage of the controller (703). The internal storage and the designed loads and weather (step 705) are then loaded into a weather prediction algorithm (step 707). From there, the predicted load (step 709) and the predicted weather (step 711) are determined, which are used as inputs to the system performance prediction model (712). From there, the new predicted performance for the system is determined at step 712, control adjustments are made at step 717 (based also on design system performance at step 715), and new component control signals are developed at step 719.

Using preconditioning, the design load can be normalized (or adjusted) to match the actual load conditions, which can be based on peaks—heating/cooling, total thermal energy in cooling and heating modes, time of year and a multiplicity of other values compared to the expected. Using the new normalized (comparing the actual thermal loads to the design thermal loads) thermal load, the control system can simulate the hybrid geothermal, hybrid geothermal, or hybrid HVAC system method (reactionary auxiliary devices functioning on a real-time basis) and pre-condition the borefield (or other thermal storage media) at a time and in a manner that is more energy efficient or has lower cost energy. The controller can determine or predict the borefield (or other thermal storage media) health, or “charge level,” both on a real-time and a projected future horizon. It can also determine the amount of heating/cooling available in geothermal HVAC, hybrid geothermal HVAC, or hybrid HVAC system borefield (or other thermal storage media); identifies potential problems such as over cooling or heating the borefield (or other thermal storage media). Finally, the controller can project building performance for upcoming year(s) based on historical performance, weather forecasts, and/or energy rate structures.

### Additional

An important feature of the technology described herein is the real-time tracking of historical building or campus thermal loads and the related geothermal, hybrid geothermal, or hybrid HVAC system asset response. This rich operational history positions the system to be evaluated for additional loads in the future to determine the most cost-effective solution for adding more load or buildings to the system. This feature is not possible in current geothermal, hybrid geothermal, or hybrid HVAC system control systems because they do not measure, record and analyze actual energy use patterns and system capacities, nor do they use these patterns and capacities to determine more efficient operating modes.

The systems and methods herein can measure and track thermal supply and demand with weather, and maintaining trends. The systems includes a performance database that allows decisions on adding loads or buildings to the existing infrastructure, which can determine what capacity is available and the optimum method for increasing the capacity for the additional loads.

The intelligent control structures herein also allow additional control parameters to be added such as real-time (Smart Grid) electrical pricing and using this additional information in concert with past performance, forecasted weather, forecasted energy costs and similar information to determine an optimal operational strategy.

The control structures described herein are open-ended to allow the addition of other energy assets such as combined heat and power systems, advanced large-scale battery systems, renewable energy systems, short-term thermal energy storage systems such as ice or phase change materials, and various geothermal heat exchangers such as vertical loops, horizontal loops, pond loops, open wells, and irrigation systems.

The methods described herein can also be applied to arrive at calculations of actual soil thermal conductivity and thermal diffusivity. In an exemplary method, knowing the normalized actual load history and the actual borefield (or thermal storage device) performance history, the soil thermal conductivity that would have been required to give the current MET is then calculated

The methods and systems herein advantageously provide for a reduction of energy use, and in some cases amounts to an energy and capital reduction. As described herein, multiple sources and sinks can be controlled individually to be able to use each source at a variable level to optimize the complete system. An exemplary commercial advantage of such a system is that, compared to traditional ASHRAE hybrid control methods that represent the current market approach, the seasonal pre-conditioning as outlined herein provides a method for eliminating annual temperature increases in the geothermal heat exchanger (or other thermal storage device) that over time will reduce cooling efficiency and maybe even cause system failure due to high temperatures.

The methods and systems herein also provide an efficient conversion of electrical to thermal energy. An exemplary commercial advantage is that the pre-conditioning technique described herein can provide significant reduction in the fluid temperature of cooling-dominated (most commercial buildings) geothermal heat exchanger over extended time periods. This lower sink temperature can provide higher cooling efficiencies and reduce the cost of the electrical to thermal energy conversion. In some embodiments, some or all of initial cost, life-cycle cost, low energy consumption, and low peak electrical demand are considered when optimizing or controlling the system.

### Specific Example

The outline below provides a merely exemplary detailed view of optimization techniques for modeling and use as described herein. Not all steps need be included to optimize one or more of modeling and use.
Calculate building load in 8760 hour form from Trane TRACE 700 (or similar 8760 hour building load simulation software)
Adjust the building loads for the addition of (cooling mode) or subtraction of (heating mode) heat pump compressor heat
Determine method for expressing building hydronic loop heat flux
   Define constant flow @ maximum cooling load (i.e. 3 GPM/ton of refrigeration for max cooling), calculate variable delta T, or
   Define constant delta T, apply variable flow constraint to building loop, or . . .
   End result is load on building hydronic loop—modeling method differs based on application/desired outcome
Assemble 8760 TMY (Typical Meteorological Year) data
   Outside Air Dry bulb Temperature
   Pressure in atmosphere (used for wet cooler model)
   Outside Air Wet bulb Temperature/Relative Humidity/Dew point Temperature: need one humidity point, custom Psychometric tool can calculate the others
Convert input arrays to MATLAB array format
Define boundary conditions for borefield in MATLAB input files
   Min/max flow inlet temperature
   Min/max flow inlet rate
   Min/max air DB
   Min/max MET (effective Mean Effective Earth Temperature for the GHX)
   Min/max # bores
Define borefield parameters in MATLAB input file
   Depth
   Hole radius
   Soil thermal conductivity
   Soil thermal diffusivity
   Etc.
Generate automatic neural net training data for borefield using custom MATLAB/TRNSYS code (automated process)
Create neural net model of borefield from training results (automated process)
If the existing dry and wet cooler models are inadequate, the above process would be followed to generate new ANN models for the coolers as well
Define simulation boundary conditions (simulation length, loop temperature limits, etc.) in MATLAB input file
Create/modify/use existing building loop Intelligent System Model (ISM) depending on problem
Particle Swarm Optimization (PSO) for determination of optimum configuration (# boreholes, depth, and closed-circuit cooling tower size)
With the PSO results:
   Given # boreholes for site and fluid cooler size,
   Run baseline ASHRAE-hybrid-like simulation to calculate annual MET rise
   With given size (particle), run cooling optimization simulation—
      Two possible scenarios: (1) optimize fluid cooler run time to achieve lowest annual MET rise with least annual electric cost, or (2) optimize fluid cooler run time to achieve lowest annual MET rise in the most efficient manner. We almost always use option 2 because we only have a guess at the 8760 electric rate data.
   End result borefield size/tower size optimized for (1) lowest installed cost and (2) lowest annual MET rise, AND optimum cooler run schedule at this solution
   This is an automated process—user inputs boundary conditions and waits.
Convert performance arrays, transfer function and run schedules to data files (delimited text files) for use in Java module (automated process)
   Extract performance transfer function from neural net
   Transfer function and coefficients are stored in data files
   Eliminates need for neural net or TRNSYS or MATLAB on PLC (Programmable Logic Controller or local HVAC control device)—all calculations are performed with transfer function representation of ANN
Modify JAVA module parameters as appropriate for job
Assemble transfer function into JAVA performance module
   Calculates MET+flow outlet temperature of borefield
   Calculates design MET
   Calculates tower run schedule
   Updates schedule based on past performance
   Predicts cooling requirements deviations from design out to five days ahead
Compile into executable PLC code
Load solution onto PLC
Then for continual optimization:
   Upload data to remote server
   Manipulate data to get into an hourly format
   Determine actual building load on system
   Determine and scrub any outliers (as in equipment malfunctions, or generally bad
   data for whatever reason)
   Normalize design data to match actual conditions
      Based on
         Peaks Heat/Cool
         Total heat in Cooling and Heating
         Time of year values compared to expected
      Weigh and average normalized values
   Using new normalized design load—simulate both ASHRAE method (Reactionary Auxiliary devices) and pre conditions borefield
      Determines (and ultimately predicts) borefield health (or “charge level”)
      Amount of Heating/Cooling available in borefield
      Potential problems
      Project building performance for upcoming year(s).

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1. A method of designing an optimized heating and cooling system, the method comprising:
simulating energy use of a virtual heating and cooling system operating a first potential thermal source or sink under a plurality of conditions;
simulating energy use of the virtual heating and cooling system operating a second potential thermal source or sink under a plurality of conditions;
optimizing the energy use of the virtual system operating the first potential thermal source or sink or the second potential thermal source or sink using neural network optimization; and
designing a heating and cooling system based upon the optimization of the energy use of the virtual system.

2. The method of claim 1, further comprising virtually connecting each of the potential thermal sources or sinks in a model to simulate the performance of the entire system as a whole before the simulating steps.

3. The method of claim 1, wherein designing the heating and cooling system comprises selecting a plurality of thermal sources or sinks for use in the heating and cooling system.

4. The method of claim 3, wherein designing the heating and cooling system further comprises determining an optimum sequence of operation of the selected plurality of thermal sources or sinks.

5. (canceled)

6. (canceled)

7. The method of claim 1, wherein the plurality of conditions includes a plurality of flow rates to or from the first or second potential thermal source or sink.

8. The method of claim 1, wherein the plurality of conditions includes a plurality of capacities of the first or second potential thermal source or sink that may vary over time or over a range of conditions.

9. (canceled)

10. (canceled)

11. (canceled)

12. (canceled)

13. (canceled)

14. The method of claim 1, wherein the neural network optimization is particle swarm optimization.

15. The method of claim 1, wherein at least one of the thermal sources or sinks is a geothermal borefield.

16. The method of claim 1, wherein at least one of the thermal sources or sinks is a closed-circuit cooling tower.

17. (canceled)

18. (canceled)

19. A method of controlling a plurality of thermal energy sources or sinks of a heating and cooling system, the method comprising:
activating the plurality of thermal sources or sinks of the heating and cooling system based upon a predetermined control plan;
tracking the performance of the heating and cooling system and each of the thermal sources or sinks under the predetermined control plan;
modifying the predetermined control plan based upon the tracked performance; and
activating the plurality of thermal sources or sinks based upon the modified control plan.

20. (canceled)

21. (canceled)

22. (canceled)

23. (canceled)

24. A method of controlling a plurality of thermal sources or sinks of a heating or cooling system, the method comprising:
predicting an increase or decrease in the temperature of one of the plurality of thermal sources or sinks;
determining an impact of the predicted increase or decrease on a capacity of the system, efficiency of the system, energy consumption of the system or cost; and
adjusting a temperature of one of the plurality of thermal energy sources or sinks based upon the determined impact.

25. (canceled)

26. The method of claim 24, wherein determining an impact of the predicted increase or decrease further comprises determining if a thermal mass of one of the plurality of thermal energy sources of sinks may be depleted or overfilled as a result of the increase or decrease in air temperature.

27. (canceled)

28. (canceled)
